(19) United States
(12) Patent Application Publication
(10) Pub. No.: US 2003/0146092 A1
(43) Pub. Date: Aug. 7, 2003

(54) Sensor element for an electrochemical sensor

(76) Inventors: Detlef Heimann, Gerlingen (DE); Thomas Wahl, Pforzheim (DE); Torsten Handler, Stuttgart (DE)

Correspondence Address: KENYON & KENYON, ONE BROADWAY, NEW YORK, NY, 10004, US

(21) Appl. No.: 10/306,660

(22) Filed: Nov. 25, 2002

(30) Foreign Application Priority Data
Nov. 24, 2001 (DE) 10157736.2-52

(51) Int. Cl. G01N 27/26

(52) U.S. Cl. 204/424; 204/431

(57) ABSTRACT

A sensor element for an electrochemical sensor for determining a physical variable of a gas mixture, for example, for a lambda probe for determining the oxygen concentration in the exhaust gas of an internal combustion engine, having a composite of sheets, which lie on top of each other, made from a solid electrolyte. The composite may have at least one electrochemical cell, including two electrodes, which may be applied to a solid electrolyte, as well as an integrated heater element. In order to achieve an additional electric insulation of the heater element, the electrochemical cell and the heater element may be connected to one another via an insulating, non-ion conductive sheet binder.

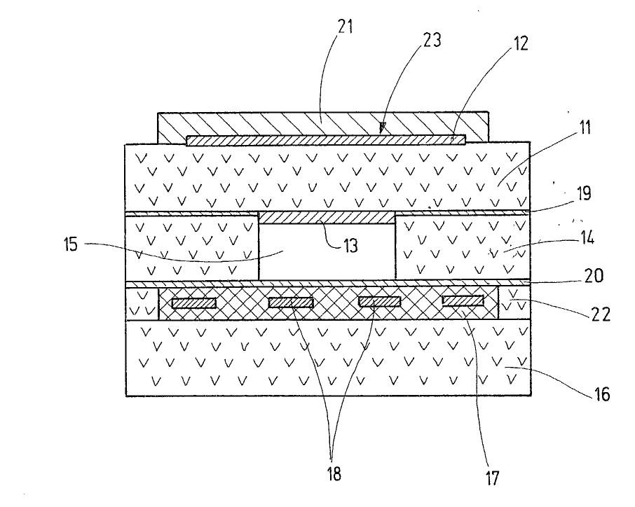

### FIELD OF THE INVENTION

The present invention relates to a sensor element for an electrochemical sensor for determining a physical variable of a gas mixture, for example, for a planar lambda probe for determining the oxygen concentration in the exhaust gas of an internal combustion engine.

### BACKGROUND INFORMATION

In the electrochemical sensor in German Patent Application Number 198 57 470, the sheet binder between the heater sheet and the reference channel sheet is made from an electron-conductive and, preferably, also ion-conductive ceramic in order to achieve a lower sensitivity of the sensor against high voltages between the heater element and the electrodes of the electrochemical cell, as well as to reduce the leakage of interference signals into the electrochemical cell by the heater element.

### SUMMARY OF THE INVENTION

A sensor element for an electrochemical sensor according to an example embodiment of the present invention may include an additional electric insulation of the integrated heater element due to a non-ion conductive and non-electrode conductive sheet binder situated between the heater element and the electrochemical cell and, for example, applied by screen printing, thereby reducing the leakage current of the heater element and the injection of interference into the sensor signal by the heater element.

According to an example embodiment of the present invention, the sheet binder is made from a paste having a high proportion of a mixed oxide containing yttrium oxide (Y₂O₃) and zirconium oxide (ZrO₂), to which ions of pentavalent metals have been added. The ions of the pentavalent metals, added to the paste, diffuse the adjacent zirconium oxide substrate and neutralize again the oxygen-ion-vacancy-forming effect of the yttrium oxide additive in the zirconium oxide, so that the oxygen-ion conductivity of the zirconium oxide substrate may be drastically reduced. This results in the above-mentioned effect of decoupling the integrated heater element and the electrochemical cell without negatively affecting the mechanical strength of the composite of the different sheets.

According to another example embodiment of the present invention, the addition of the metal ions may be carried out in the form of compounds of the elements niobium (Nb), antimony (Sb), bismuth (Bi), or tantalum (Ta). The added metal compounds are oxides, carbonates, or nitrates, e.g., niobium oxide (Nb₂O₅).

### BRIEF DESCRIPTION OF THE DRAWING

The drawing shows a schematic cross section of an exemplary embodiment of a sensor element for a planar lambda probe according to an example embodiment of the present invention.

### DETAILED DESCRIPTION

An example embodiment of an electrochemical sensor for determining a physical variable in a gas mixture according to the present invention is illustrated in the drawing as a sensor element for a planar lambda probe for determining the oxygen concentration in the exhaust gas of an internal combustion engine. This may include a composite of sheets, which lie on top of each other, made of an ion-conductive solid electrolyte, which may be composed of a mixed oxide of yttrium oxide (Y₂O₃) and zirconium oxide (ZrO₂) , also known as Y₂O₃-stabilized, or partially Y₂O₃-stabilized zirconium oxide, which, with an addition of an organic binder phase, may be processed into ceramic sheet substrates, using a sheet casting method. An electrochemical cell 23, having two electrodes, which may be separated by a solid electrolyte and a heater element 18, may be integrated in the composite. In the illustrated exemplary embodiment, electrochemical cell 23 is designed as a Nernst cell. In addition to the Nernst cell, the composite may also include a pump cell, so that a double-cell limit current probe is implemented. The composite may include an upper cell sheet 11, to which the two electrodes of electrochemical cell 23 are applied as outside electrode 12 and inside electrode 13, for example, by using a screen printing or thick-film method; a middle reference channel sheet 14 having a reference gas channel 15 in the area of inside electrode 13; and a lower heater sheet 16, to which heater element 18, integrated in an electric insulation 17 made from, for example, aluminum oxide (Al₂O₃), is applied. Heater element 18 may be embedded in insulation 17 in a helical form, as in the depicted exemplary embodiment where only the cross sections of the individual coil loops are visible. At the edges, insulation 17 may be enclosed by a sealing frame 22 made from a solid electrolyte.

Upper cell sheet 11 and middle reference channel sheet 14 may be connected to one another via a first sheet binder 19, and middle reference channel sheet 14 and heater sheet 16 may be connected to one another via a second sheet binder 20. First sheet binder 19, recessed in the area of inside electrode 13, is a standard sheet binder and may be made from stabilized zirconium oxide (ZrO₂). Second sheet binder 20 extends across the entire surface of reference channel sheet 14, facing heater element 18, and across the surface of electric insulation 17 and of sealing frame 22, facing reference channel sheet 14.

Second sheet binder 20 may be designed to be electrically insulating and non-ion conductive, in order to increase the electric insulation of cell sheet 11 having electrodes 12, 13 with respect to heater element 18 and to largely suppress the leakage of interference into the sensor signal picked off between electrodes 12, 13. In order to achieve this, second sheet binder 20 may be made from a paste having a high proportion of a mixed oxide containing yttrium oxide (Y₂O₃) and zirconium oxide (ZrO₂) to which ions of pentavalent metals have been added. The metal ions are added in the form of compounds of the pentavalent metals, such as, niobium (Nb), antimony (Sb), bismuth (Bi), or tantalum (Ta). The added metal compounds are oxides, carbonates, or nitrates of these metals.

In an exemplary embodiment, niobium oxide (Nb₂O₅) may be added to the mixed oxide containing yttrium oxide and zirconium oxide; the proportion of niobium oxide in the paste may be up to 20% by weight calculated on the proportion of the yttrium oxide-zirconium oxide mixture. The proportion may be selected to be between eight and ten percent by weight. In order to increase the electric insulation, aluminum oxide (Al₂O₃) may be added to the paste, the added proportion of aluminum oxide amounting to up to fifty percent by weight.

In an exemplary embodiment of second sheet binder 20, the paste, having a solid content of 66.85%, contains the following solid components with the following percentages by weight:

| | |
|---|---|
| Niobium oxide (Nb₂O₅) | 6.55% |
| Aluminum oxide (Al₂O₃) | 0.50% |
| Silicon dioxide (SiO₂) | 0.80% |
| Stabilized zirconium oxide (Y₂O₃/ZrO₂₎ | 59.00% |

By adding an organic binder phase, the solid components are processed into a printable paste.

What is claimed is:

1. A sensor element for an electrochemical sensor, comprising:
a composite of sheets disposed one on top of another and made of an ion-conductive solid electrolyte, the composite including at least one electrochemical cell having a first electrode separated from a second electrode by a solid electrolyte, a heater element disposed between the first and second electrodes, and a sheet binder disposed between the electrochemical cell and the heater element, wherein the sheet binder is electrically insulating and non-ion conductive.

2. The sensor element according to claim 1, wherein the sensor is configured to determine a physical variable of a gas mixture.

3. The sensor element according to claim 1, wherein the sensor is configured as a planar lambda probe for determining oxygen concentration in exhaust gas of an internal combustion engine.

4. The sensor element according to claim 1, wherein the sheet binder is made from a paste having a high proportion of a mixed oxide containing yttrium oxide and zirconium oxide ions to which of pentavalent metals are added.

5. The sensor element according to claim 4, wherein the metal ions are added in a form of a compound including at least one of niobium, antimony, bismuth, and tantalum.

6. The sensor element according to claim 5, wherein the compound is one of oxides, carbonates, or nitrates.

7. The sensor element according to claim 6, wherein the compound is a niobium oxide.

8. The sensor element according to claim 7, wherein the paste includes up to 20% niobium oxide by weight.

9. The sensor element according to claim 8, wherein the paste includes 8%-10% niobium oxide by weight in accordance with the proportion of the mixed oxide.

10. The sensor element according to claim 4, wherein the paste includes aluminum oxide.

11. The sensor element according to claim 10, wherein the paste includes up to 50% aluminum oxide by weight.

12. The sensor element according to claim 10, wherein, at a solid content of 66.85% by weight, the paste includes, by weight, 6.55% niobium oxide, 0.50% aluminum oxide, 0.80% silicon dioxide, and 59.00% stabilized zirconium oxide, each in solid form.

13. The sensor element according to claim 13, wherein the solid components include solvents and organic ingredients.

14. The sensor element according to claim 1, wherein the sheets include an upper cell sheet, a middle reference channel sheet, and a laser heater sheet, the first electrode being disposed on an outside of the upper cell sheet, the second electrode being disposed on an inside of the upper cell sheet, the heater element together with a surrounding electric insulation being accommodated by the heater sheet, and wherein the middle reference channel sheet has a reference gas channel, the middle reference channel sheet lying between the upper cell sheet and the heater sheet.

15. The sensor element according to claim 15, further comprising:
a sealing frame made from a solid electrolyte and configured to enclose the surrounding insulation at edges of the surrounding insulation.

16. The sensor element according to claim 14, wherein the sheet binder extends between the middle reference channel sheet and the surrounding insulation including the sealing frame.

17. The sensor element according to claim 14, wherein the upper cell sheet and the middle reference channel sheet are connected to one another by the sheet binder, the sheet binder including yttrium oxide-stabilized zirconium oxide and is recessed in an area of the second electrode.

18. The sensor element according to claim 15, wherein the ion-conductive solid electrolyte is made of a mixed oxide of yttrium oxide and zirconium oxide.
